(19) United States
(12) Patent Application Publication
(10) Pub. No.: US 2015/0263319 A1
(43) Pub. Date: Sep. 17, 2015

(54) BATTERY PACK

(71) Applicant: Samsung SDI Co., Ltd., Yongin-si (KR)

(72) Inventor: Kyung-Suk KO, Yongin-si (KR)

(21) Appl. No.: 14/638,768

(22) Filed: Mar. 4, 2015

(30) Foreign Application Priority Data
Mar. 13, 2014 (KR) 10-2014-0029761

(51) Int. Cl. H01M 2/10; H01M 10/42; H01M 2/30

(52) U.S. Cl. CPC H01M 2/1061; H01M 2/30; H01M 10/4257; H01M 2200/10; H01M 2220/30

(57) ABSTRACT

A battery pack includes: a can accommodating an electrode assembly; a cap plate coupled to the can and including an electrode terminal; a holder disposed on the cap plate and including a terminal exposing portion through which the electrode terminal is exposed; a circuit unit disposed on a side of the holder; and an electrode tab connecting the circuit unit and the electrode terminal. The holder further includes a pair of barrier walls disposed around the terminal exposing portion to respectively cover both lateral surfaces of the electrode tab.

### RELATED APPLICATIONS

This application claims the benefit of Korean Patent Application No. 10-2014-0029761, filed on Mar. 13, 2014, in the Korean Intellectual Property Office, the disclosure of which is incorporated herein in its entirety by reference.

### BACKGROUND

1. Field

One or more embodiments of the present invention relate to a battery pack.

2. Description of the Related Technology

Various battery packs are used as power sources of portable electronic devices. In the same regard, as portable devices are widely used in various fields, demand for battery packs has markedly increased. Since battery packs can be repeatedly used after being recharged, they are economical and eco-friendly devices, and thus, the use of battery packs has been strongly encouraged.

As electronic devices are required to be small and light, battery packs are also required to be small and light. However, since highly reactive materials such as lithium are included in battery packs, there is a limit in reducing the size and weight of battery packs due to safety concerns. Therefore, much research has been conducted to reduce the size and weight of battery packs while improving the safety thereof.

### SUMMARY

One or more embodiments of the present invention include a battery pack having improved safety.

Additional aspects will be set forth in part in the description which follows and, in part, will be apparent from the description, or may be learned by practice of the presented embodiments.

According to one or more embodiments of the present invention, a battery pack includes: a can accommodating an electrode assembly; a cap plate coupled to the can and including an electrode terminal; a holder disposed on the cap plate and including a terminal exposing portion through which the electrode terminal is exposed; a circuit unit disposed on a side of the holder; and an electrode tab connecting the circuit unit and the electrode terminal, wherein the holder further includes a pair of barrier walls disposed around the terminal exposing portion to respectively cover both lateral surfaces of the electrode tab.

The pair of barrier walls may have a height greater than a thickness of the electrode tab.

The circuit unit may include: a body including a circuit pattern therein; a first lead plate extending outward from a side of the body and exposed outward; and a second lead plate extending outward from an opposite side of the body and exposed outward, wherein the first lead plate may be connected to the electrode tab, and the second lead plate may be coupled to the cap plate.

The secondary battery may further include a thermal protection device disposed between the first lead plate and the electrode tab.

The battery pack may further include a recess to receive the body.

The holder may further include a stopper to confine the electrode tab between the pair of barrier walls, the stopper being formed on a peripheral side of the terminal exposing portion.

The holder may further include a fixing portion on an end portion thereof in a length direction of the cap plate, wherein the fixing portion may be located at a side opposite the circuit unit.

The fixing portion may include a dummy electrode extending outward from the holder and exposed outward, and the dummy electrode may be coupled to the cap plate.

The fixing portion may include a protrusion protruding from the holder toward the cap plate, and the cap plate may further include a recess to receive the protrusion.

The battery pack may further include a cover covering the holder, wherein the holder may further include a first coupling portion on a lateral surface thereof, and the cover may include a second coupling portion configured to be coupled to the first coupling portion.

Another side of the holder opposite the side of the holder on which the circuit unit is disposed may have a height equal to the sum of a height of the side of the holder and a height of the circuit unit.

The cover may further include a support protruding from a lower surface thereof toward the holder, and a recess configured to receive the support may be formed in a side of the holder opposite the side of the holder on which the circuit unit is disposed.

According to one or more embodiments of the present invention, a battery pack includes: a can accommodating an electrode assembly; a cap plate coupled to the can and having a first polarity; an electrode terminal formed on the cap plate and having a second polarity; a circuit unit electrically connected to the cap plate and the electrode terminal; and a holder disposed between the circuit unit and the cap plate, wherein the circuit unit includes: a body including a circuit pattern therein; a first lead plate extending from a side of the body and electrically connected to the electrode terminal; and a second lead plate extending from an opposite side of the body and coupled to the cap plate, wherein the holder includes: a recess to receive the body; and a terminal exposing portion through the electrode terminal is exposed, wherein a pair of barrier walls parallel with each other are formed around the terminal exposing portion.

The battery pack may further include an electrode tab connecting the first lead plate and the electrode terminal, wherein the pair of barrier walls may respectively cover both lateral surfaces of the electrode tab.

The secondary battery may further include a thermal protection device disposed between the first lead plate and the electrode tab.

The holder may further include a stopper to confine the electrode tab between the pair of barrier walls, and the stopper may be formed on a peripheral side of the terminal exposing portion.

The circuit unit may be disposed on a side of the holder, and an opposite side of the holder may have a height equal to the sum of a height of the side of the holder and a height of the circuit unit.

The holder may further include a fixing portion formed on an end portion thereof in a length direction of the cap plate, the fixing portion being located at a side opposite the circuit unit.

The battery pack may further include a cover covering the holder, wherein the holder may further include a first coupling portion on a lateral surface thereof, and the cover may include a second coupling portion configured to be coupled to the first coupling portion.

The cover may further include a support protruding from a lower surface of the cover toward the holder, and a recess may be formed in the opposite side of the holder to receive the support.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view schematically illustrating a battery pack according to an embodiment of the present invention;

FIG. 2 is an exploded perspective view schematically illustrating the battery pack depicted in FIG. 1;

FIG. 3 is an exploded perspective view schematically illustrating a holder and a circuit unit depicted in FIG. 2;

FIG. 4 is a perspective view schematically illustrating a cover depicted in FIG. 2;

FIG. 5 is an exploded perspective view schematically illustrating a modification example of the battery pack depicted in FIG. 1; and

FIG. 6 is a schematic cross-sectional view taken along line I-I of FIG. 5.

### DETAILED DESCRIPTION OF CERTAIN INVENTIVE EMBODIMENTS

Reference will now be made in detail to the following embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. Moreover, detailed descriptions related to well-known functions or configurations will be ruled out in order not to unnecessarily obscure subject matters of the present invention.

It will be understood that although the terms “first” and “second” are used herein to describe various elements, these elements should not be limited by these terms. These terms are only used to distinguish one element from other elements.

In the following description, technical terms are used only for explaining a specific exemplary embodiment and do not limit the present invention. The meaning of ‘include’ or ‘comprise’ specifies a property, a fixed number, a step, a process, an element, a component, and a combination thereof but does not exclude other properties, fixed numbers, steps, processes, elements, components, and combinations thereof.

Hereinafter, the embodiments of the present invention will be described in detail with reference to the accompanying drawings.

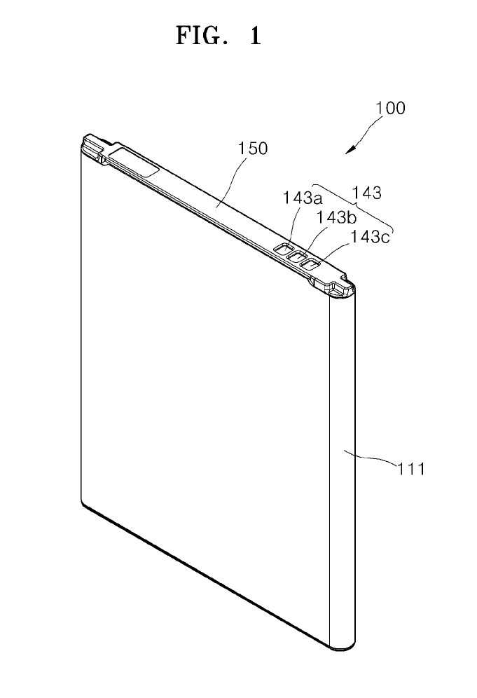

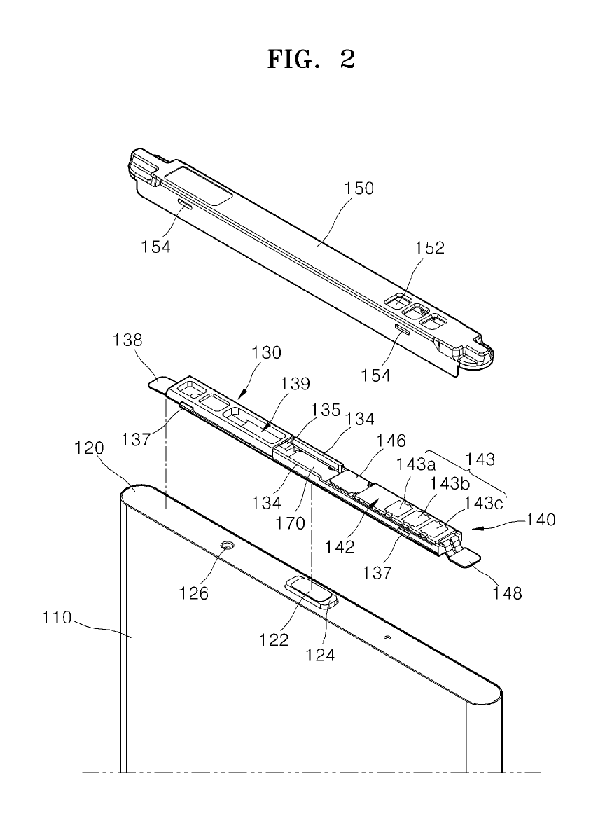

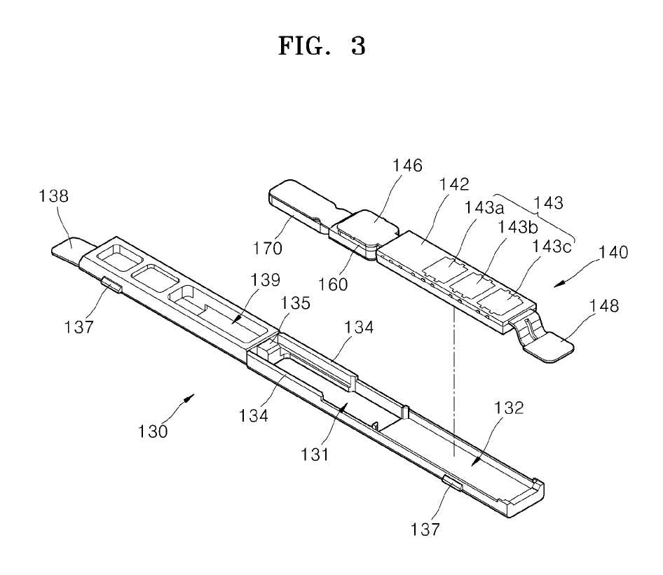

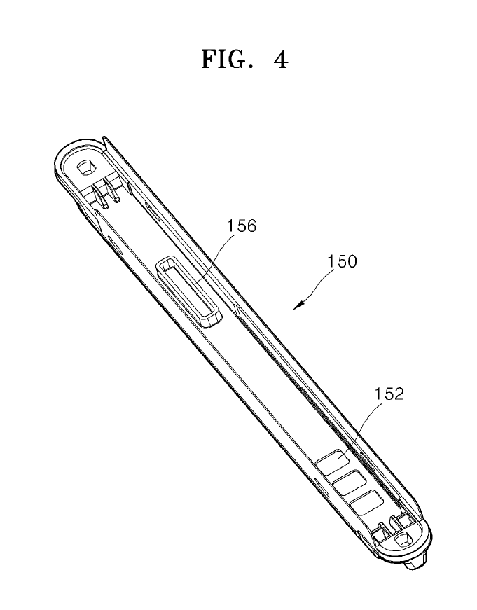

FIG. 1 is a perspective view schematically illustrating a battery pack 100 according to an embodiment of the present invention, and FIG. 2 is an exploded perspective view schematically illustrating the battery pack 100 of FIG. 1. FIG. 3 is an exploded perspective view schematically illustrating a holder 130 and a circuit unit 140 depicted in FIG. 2, and FIG. 4 is a perspective view schematically illustrating a cover 150 depicted in FIG. 2.

Referring to FIGS. 1 to 4, the battery pack 100 of the embodiment may include a can 110 accommodating an electrode assembly (not shown), a cap plate 120 coupled to the can 110, the holder 130 disposed on the cap plate 120, the circuit unit 140 disposed on the holder 130, and a cover 150 enclosing the holder 130.

The electrode assembly (not shown) may include positive and negative electrode plates coated with electrode active materials, and a separator disposed between the positive and negative electrode plates. For example, the electrode assembly (not shown) may be a jelly-roll type electrode assembly formed by sequentially stacking the negative electrode plate, the separator, and the positive electrode plate to form an electrode stack, and rolling up the electrode stack. In another example, the electrode assembly (not shown) may be a stacking type electrode assembly formed by sequentially stacking the negative electrode plate, the separator, and the positive electrode plate.

An opening (not shown) is formed in an upper side of the can 110 to insert the electrode assembly into the can 110. The can 110 is formed of a conductive member such as an aluminum or an aluminum alloy. The can 110 may protect the electrode assembly (not shown) from impacts, and during charging and discharging operations of the electrode assembly (not shown), the can 110 may function as a heat-dissipation plate to dissipate heat from the electrode assembly (not shown) to the outside.

The cap plate 120 may be formed of the same material as that used to form the can 110. After the electrode assembly (not shown) is disposed in the can 110, the cap plate 120 may be placed on a side of the can 110 and coupled to the can 110 by welding, for example.

An electrode terminal 122 may be disposed on the cap plate 120. The electrode terminal 122 may be electrically connected to the negative electrode plate (not shown) of the electrode assembly (not shown). In addition, the positive electrode plate (not shown) of the electrode assembly (not shown) may be electrically connected to the cap plate 120. However, the embodiments of the present invention are not limited thereto. For example, the electrode terminal 122 may be electrically connected to a positive electrode of the electrode assembly (not shown), and the cap plate 120 may be electrically connected to a negative electrode of the electrode assembly (not shown). An insulator 124 may be disposed between the electrode terminal 122 and the cap plate 120 to prevent a short circuit.

The cap plate 120 may include an electrolyte injection hole 126. After the cap plate 120 is coupled to the can 110, an electrolyte may be injected into the can 110 through the electrolyte injection hole 126, and then the electrolyte injection hole 126 may be closed using a plug (not shown).

The holder 130 may be disposed on the cap plate 120, and the circuit unit 140 may be disposed on a side of the holder 130. The holder 130 may include a terminal exposing portion 131 through which the electrode terminal 122 is exposed, a pair of barrier walls 134 and a stopper 135 formed around the terminal exposing portion 131, a recess 132 in which a body 142 of the circuit unit 140 is disposed, and a fixing portion 138.

The circuit unit 140 may prevent overcharging, overdischarging, and the occurrence of an overcurrent, short circuits, and reverse voltage in the battery pack 100, and thus may prevent explosion, overheating, leakage, deterioration of charge-discharge characteristics, deterioration of electric performance, and abnormal behaviors of the battery pack 100. That is, the circuit unit 140 prevents or removes hazards and increases the lifespan of the battery pack 100.

The circuit unit 140 may include a body 142 including a circuit pattern therein, a first lead plate 146 extending outward from a side of the body 142, and a second lead plate 148 extending outward from an opposite side of the body 142.

The body 142 may be disposed in the recess 132, and in this state, the body 142 may be fixed. The body 142 may be formed of an insulator, and the circuit pattern of the body 142 may include a plurality of devices and lines.

The plurality of devices may be provided in the form of an integrated circuit including switching devices, resistors, capacitors, and varistors. The lines may be formed of wires to electrically connect the plurality of devices and may form the circuit pattern together with the plurality of devices.

For example, the body 142 may be formed by arranging a plurality of devices and lines on a metal pattern to form a circuit pattern, and molding the circuit pattern with a polymer resin such as polycarbonate. That is, the body 142 is formed by packaging electronic devices together on a printed circuit board so as to reduce the size of the body 142, thereby decreasing the installation area of the circuit unit 140 and the size of the battery pack 100.

A pad 143 may be formed on the body 142 to be electrically connected to external electronic devices. The pad 143 may include a first pad 143a to receive a first voltage, a second pad 143b to receive a second voltage, and a third pad 143c as a ground pad.

The first lead plate 146 is electrically connected to the electrode terminal 122, and the second lead plate 148 is electrically connected to the cap plate 120 so that a current may flow from the electrode assembly (not shown) to the circuit unit 140. In detail, the first lead plate 146 may be electrically connected to the electrode terminal 122 through an electrode tab 170, and the second lead plate 148 may be coupled to the cap plate 120 by welding, for example.

A side of the electrode tab 170 may be coupled to the first lead plate 146 by welding, for example, and an opposite side of the electrode tab 170 may be coupled to an exposed side of the electrode terminal 122 through a terminal exposing portion 131 by welding, for example.

In addition, a thermal protection device 160 may be disposed between the electrode tab 170 and the first lead plate 146. The thermal protection device 160 may prevent burning or explosion of the battery pack 100 caused by an overcurrent. The thermal protection device 160 may reversibly function as a conductor or an insulator according to temperature. For example, the thermal protection device 160 may be a polymer positive temperature coefficient (PTC) device formed by dispersing conductive particles such as metal or carbon particles into a crystalline polymer. However, the thermal protection device 160 is not limited thereto.

When the body 142 is placed in the recess 132, the electrode tab 170 coupled to the first lead plate 146 may be placed on the terminal exposing portion 131, and both lateral surfaces of the electrode tab 170 may be covered by the pair of barrier walls 134 formed around the terminal exposing portion 131.

The pair of barrier walls 134 are parallel with each other, and the height of the pair of barrier walls 134 may be greater than the thickness of the electrode tab 170. Owing to this structure, the electrode tab 170 is less likely to short-circuit with other parts, and the battery pack 100 may operate more stably. Particularly, for example, when a plurality of battery packs 100 are arranged side by side in a state where covers 150 are not yet coupled to the battery packs 100, even though one of the battery packs 100 falls, lateral surfaces of an electrode tab 170 of the battery pack 100 may be effectively prevented from making contact with another battery pack 100.

The stopper 135 may be formed on a peripheral side of the terminal exposing portion 131 to fix the position of the electrode tab 170. In detail, since the terminal exposing portion 131 is formed between the pair of barrier walls 134, the electrode tab 170 may be moved away from the terminal exposing portion 131 in a length direction of the cap plate 120. The stopper 135 prevents such movement of the electrode tab 170.

The fixing portion 138 may be formed on an end portion of the holder 130 in a length direction of the cap plate 120 to fix the holder 130. Therefore, when the second lead plate 148 of the circuit unit 140 disposed on a side of the holder 130 is welded on the cap plate 120, the position of the circuit unit 140 may not change or the holder 130 may not be pushed away. Therefore, the battery pack 100 may be stably manufactured.

For example, as shown in FIG. 2, the fixing portion 138 may include a dummy electrode exposed to the outside. The dummy electrode may extend outward from the holder 130. The holder 130 may be stably fixed to the cap plate 120 by coupling the dummy electrode to the cap plate 120 by welding, for example.

The end portion of the holder 130 on which the fixing portion 138 is formed is an end portion of a side of the holder 130 which is opposite a side of the holder 130 on which the circuit unit 140 is disposed. As described above, since the circuit unit 140 is small due to packaging thereof, the circuit unit 140 may be disposed only on a side of the holder 130. In this case, the opposite side of the holder 130 on which the circuit unit 140 is not disposed may have a height equal to the sum of the height of the circuit unit 140 and the height of the side of the holder 130 on which the circuit unit 140 is disposed.

In this way, a gap between the holder 130 and the cover 150 may be removed to inhibit the cover 150 from being damaged by an impact. In addition, a recess 139 may be formed in the opposite side of the holder 130 to increase the coupling force between the holder 130 and the cover 150.

The cover 150 covers the holder 130 and the circuit unit 140 so that the circuit unit 140 may not be exposed. The cover 150 may include exposure holes 152 to expose the pad 143.

First coupling portions 137 may be formed on lateral surfaces of the holder 130, and second coupling portions 154 may be formed on the cover 150 for coupling with the first coupling portions 137. For example, the first coupling portions 137 may be tabs protruding from lateral surfaces of the holder 130, and the second coupling portions 154 may be holes in which the first coupling portions 137 are inserted. However, the first and second coupling portions 137 and 154 are not limited thereto.

In addition, the cover 150 may further include a support 156 protruding from a lower surface thereof toward the holder 130, and the recess 139 may be formed in the opposite side of the holder 130 to receive the support 156. That is, the recess 139 may be formed in another side of the holder 130 which is different from the side of the holder 130 on which the circuit unit 140 is disposed.

Therefore, when the cover 150 and the holder 130 are coupled using the first coupling portions 137 and the second coupling portions 154, the support 156 may be inserted into the recess 139 to increase the coupling strength between the cover 150 and the holder 130 and prevent movement of the cover 150.

The recess 139 may be formed through the holder 130 at a position corresponding to the electrolyte injection hole 126 to expose the electrolyte injection hole 126.

After the cover 150 is coupled to the holder 130, lateral surfaces of the can 110 may be wrapped with a label 111.

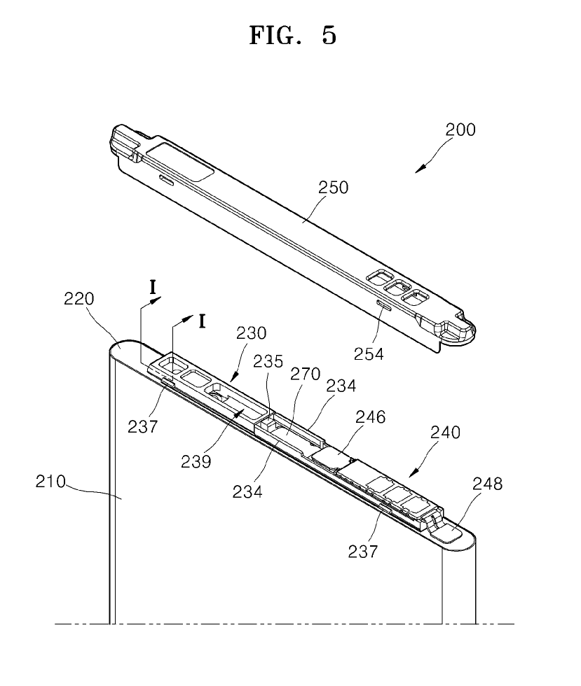

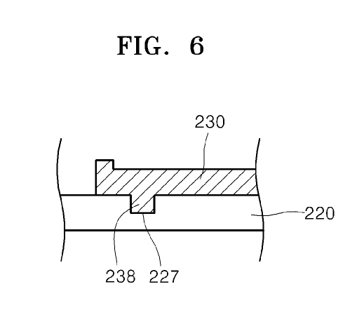

FIG. 5 is an exploded perspective view schematically illustrating a modification example of the battery pack 100 shown in FIG. 1, and FIG. 6 is a schematic cross-sectional view taken along line I-I of FIG. 5.

Referring to FIGS. 5 to 6, a battery pack 200 may include a can 210 accommodating an electrode assembly (not shown), a cap plate 220 coupled to the can 210, a holder 230 disposed on the cap plate 220, a circuit unit 240 disposed on the holder 230, and a cover 250 enclosing the holder 230.

The can 210 may be formed of a conductive material such as aluminum. The can 210 accommodates the electrode assembly (not shown). The cap plate 220 may be formed of the same material as that used to form the can 210 and may be coupled to a side of the can 210 by welding, for example.

The holder 230 is disposed on the cap plate 220. The circuit unit 240 is disposed on a side of the holder 230, and a fixing portion 238 may be formed on an end portion of the holder 230 in a length direction of the cap plate 220. The end portion of the holder 230 on which the fixing portion 238 is formed is an end portion of a side of the holder 230 which is opposite a side of the holder 130 on which the circuit unit 240 is disposed.

The circuit unit 240 may have a small size due to the packaging thereof and may be disposed only on a side of the holder 130. In this case, the opposite side of the holder 230 on which the circuit unit 240 is not disposed may have a height equal to the sum of the height of the circuit unit 240 and the height of the side of the holder 230 on which the circuit unit 240 is disposed. Therefore, a gap between the holder 230 and the cover 250 may be removed, and a recess 239 may be formed in the opposite side of the holder 230 to receive a support (not shown) of the cover 250 in the same manner as described above, thereby increasing the coupling strength between the cover 250 and the holder 230.

For example, as shown in FIG. 6, the fixing portion 238 may include a protrusion protruding from the holder 230 toward the cap plate 220. In addition, a recess 227 may be formed in the cap plate 220 to receive the fixing portion 238. Therefore, the holder 230 may be simply coupled to the cap plate 220 by inserting the holder 230 into the recess 227. Since the position of the holder 230 is fixed as described above, when a second lead plate 248 of the circuit unit 240 disposed on the side of the holder 230 is welded on the cap plate 220, the position of the circuit unit 240 may be inhibited from changing or the holder 230 may be inhibited from being pushed away.

The holder 230 may include a pair of barrier walls 234 covering both lateral surfaces of an electrode tab 270, and a stopper 235 fixing the position of the electrode tab 270. The electrode tab 270 may be electrically connected to a first lead plate 246, and a thermal protection device (not shown) may be disposed between the electrode tab 270 and the first lead plate 246.

The pair of barrier walls 234 may be parallel with each other, and the height of the pair of barrier walls 234 may be greater than the thickness of the electrode tab 270. Therefore, the electrode tab 270 may be prevented from being short-circuited with other parts. Particularly, for example, when a plurality of battery packs 200 are arranged side by side in a state where covers 250 are not yet coupled to the battery packs 200, even though one of the battery packs 200 falls, lateral surfaces of an electrode tab 270 of the battery pack 200 may be effectively prevented from making contact with another battery pack 200.

First coupling portions 237 may be formed on the holder 230, and second coupling portions 254 may be formed on the cover 250 for coupling with the first coupling portions 237. For example, the first coupling portions 237 may be tabs protruding from lateral sides of the holder 230, and the second coupling portions 254 may be holes in which the first coupling portions 237 are inserted.

The recess 239 may be formed in the holder 230 to receive the support (not shown) protruding from a lower surface of the cover 250 toward the holder 230.

As described above, according to the one or more embodiments of the present invention, battery packs may be manufactured efficiently and stably.

The effects of the embodiments of the present invention may be understood from the above description with reference to the accompanying drawings.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A battery pack comprising:
a can accommodating an electrode assembly;
a cap plate coupled to the can and comprising an electrode terminal;
a holder disposed on the cap plate and comprising a terminal exposing portion through which the electrode terminal is exposed;
a circuit unit disposed on a side of the holder; and
an electrode tab connecting the circuit unit and the electrode terminal,
wherein the holder further comprises a pair of barrier walls disposed around the terminal exposing portion to respectively cover both lateral surfaces of the electrode tab.

2. The battery pack of claim 1, wherein the pair of barrier walls has a height greater than a thickness of the electrode tab.

3. The battery pack of claim 1, wherein the circuit unit comprises:
a body comprising a circuit pattern therein;
a first lead plate extending outward from a side of the body and exposed outward; and
a second lead plate extending outward from an opposite side of the body and exposed outward,
wherein the first lead plate is connected to the electrode tab, and the second lead plate is coupled to the cap plate.

4. The secondary battery of claim 3, further comprising a thermal protection device disposed between the first lead plate and the electrode tab.

5. The battery pack of claim 3, wherein the holder further comprises a recess to receive the body.

6. The battery pack of claim 1, wherein the holder further comprises a stopper to confine the electrode tab between the pair of barrier walls, the stopper being formed on a peripheral side of the terminal exposing portion.

7. The battery pack of claim 1, wherein the holder further comprises a fixing portion on an end portion thereof in a length direction of the cap plate,
wherein the fixing portion is located at a side opposite the circuit unit.

8. The battery pack of claim 7, wherein the fixing portion comprises a dummy electrode extending outward from the holder and exposed outward, the dummy electrode being coupled to the cap plate.

9. The battery pack of claim 7, wherein the fixing portion comprises a protrusion protruding from the holder toward the cap plate, and
the cap plate further comprises a recess to receive the protrusion.

10. The battery pack of claim 1, further comprising a cover covering the holder,
wherein the holder further comprises a first coupling portion on a lateral surface thereof, and the cover comprises a second coupling portion configured to be coupled to the first coupling portion.

11. The battery pack of claim 1, wherein another side of the holder opposite the side of the holder on which the circuit unit is disposed has a height equal to a sum of a height of the side of the holder and a height of the circuit unit.

12. The battery pack of claim 10, wherein the cover further comprises a support protruding from a lower surface thereof toward the holder, and
a recess configured to receive the support is formed in a side of the holder opposite the side of the holder on which the circuit unit is disposed.

13. A battery pack comprising:
a can accommodating an electrode assembly;
a cap plate coupled to the can and having a first polarity;
an electrode terminal formed on the cap plate and having a second polarity;
a circuit unit electrically connected to the cap plate and the electrode terminal; and
a holder disposed between the circuit unit and the cap plate,
wherein the circuit unit comprises:
a body comprising a circuit pattern therein;
a first lead plate extending from a side of the body and electrically connected to the electrode terminal; and
a second lead plate extending from an opposite side of the body and coupled to the cap plate,
wherein the holder comprises:
a recess to receive the body; and
a terminal exposing portion through the electrode terminal is exposed,
wherein a pair of barrier walls parallel with each other are formed around the terminal exposing portion.

14. The battery pack of claim 13, further comprising an electrode tab connecting the first lead plate and the electrode terminal,
wherein the pair of barrier walls respectively cover both lateral surfaces of the electrode tab.

15. The secondary battery of claim 14, further comprising a thermal protection device disposed between the first lead plate and the electrode tab.

16. The battery pack of claim 14, wherein the holder further comprises a stopper to confine the electrode tab between the pair of barrier walls,
the stopper being formed on a peripheral side of the terminal exposing portion.

17. The battery pack of claim 13, wherein the circuit unit is disposed on a side of the holder, and an opposite side of the holder has a height equal to a sum of a height of the side of the holder and a height of the circuit unit.

18. The battery pack of claim 17, wherein the holder further comprises a fixing portion formed on an end portion thereof in a length direction of the cap plate, the fixing portion being located at a side opposite the circuit unit.

19. The battery pack of claim 17, further comprising a cover covering the holder,
wherein the holder further comprises a first coupling portion on a lateral surface thereof, and the cover comprises a second coupling portion configured to be coupled to the first coupling portion.

20. The battery pack of claim 19, wherein the cover further comprises a support protruding from a lower surface of the cover toward the holder, and
a recess is formed in the opposite side of the holder to receive the support.
